(19) United States
(12) Patent Application Publication
(10) Pub. No.: US 2024/0013723 A1
(43) Pub. Date: Jan. 11, 2024

(54) PIXEL DRIVING CIRCUIT, DISPLAY PANEL AND DISPLAY DEVICE

(71) Applicant: TIANMA ADVANCED DISPLAY TECHNOLOGY INSTITUTE (XIAMEN) CO., LTD., Xiamen (CN)

(72) Inventor: Yingteng ZHAI, Xiamen (CN)

(73) Assignee: TIANMA ADVANCED DISPLAY TECHNOLOGY INSTITUTE (XIAMEN) CO., LTD., Xiamen (CN)

(21) Appl. No.: 18/475,295

(22) Filed: Sep. 27, 2023

(30) Foreign Application Priority Data
Jun. 30, 2023 (CN) 202310798303.1

(51) Int. Cl. G09G 3/3233

(52) U.S. Cl. CPC G09G 3/3233; G09G 2300/0842; G09G 2310/08

(57) ABSTRACT

A pixel driving circuit, a display panel and a display device are provided. The pixel driving circuit includes a light emitting element and an amplitude modulation device. The amplitude modulation device includes a first driving transistor, a first switch transistor and a second switch transistor. The first driving transistor is configured to provide a driving current for the light emitting element, the first switch transistor and the second switch transistor are configured to selectively control the light emitting element to enter a light emitting stage, and a width-to-length ratio of a channel of the first switch transistor is different from a width-to-length ratio of a channel of the second switch transistor.

### CROSS-REFERENCE TO RELATED APPLICATIONS

This application claims benefit of priority from Chinese application NO. 202310798303.1, titled “PIXEL DRIVING CIRCUIT, DISPLAY PANEL AND DISPLAY DEVICE”, filed Jun. 30, 2023, with the China National Intellectual Property Administration, which is incorporated herein by reference in its entirety.

### FIELD

The present disclosure relates to the field of display technologies, and in particular, to a pixel driving circuit, a display panel and a display device.

### BACKGROUND

With the continuous improvement of display technologies, people are having higher and higher requirements on display devices. Among various display technologies, the self-light-emitting display device is widely applied to various electronic device, such as computers and cellphones, due to its advantages such as self-light-emitting, light weight and thinness, low power consumption, high contrast, wide color gamut and capability of flexible display. A self-light-emitting element in a conventional self-light-emitting display device is generally an organic light emitting diode (OLED), a quantum dot light emitting diode (QLED), or a micro light emitting diode (Micro LED). In practice, display of images is implemented by a pixel driving circuit driving a light emitting element.

Generally, multiple switch transistors are connected in series in a current driving loop in the pixel driving circuit, and switch transistors at different positions in the current driving loop have different cross voltages, which causes ineffective power loss to a switch transistor with a high cross voltage in the current driving loop and therefore increases power consumption of a display panel.

### SUMMARY

In order to address the above problem, a pixel driving circuit, a display panel and a display device are provided according to the present disclosure.

In one embodiment, a pixel driving circuit is provided according to the present disclosure, which includes a light emitting element and an amplitude modulation device, where the amplitude modulation device includes a first driving transistor, a first switch transistor and a second switch transistor,

the first driving transistor is configured to provide a driving current for the light emitting element,

the first switch transistor and the second switch transistor are configured to selectively control the light emitting element to enter a light emitting stage, and

a width-to-length ratio of a channel of the first switch transistor is different from a width-to-length ratio of a channel of the second switch transistor.

In one embodiment, a display panel is further provided according to the present disclosure, which includes the pixel driving circuit according to the embodiments.

In one embodiment, a display device is further provided according to the present disclosure, which includes the display panel according to the embodiments.

### BRIEF DESCRIPTION OF THE DRAWINGS

The accompanying drawings, which are incorporated in and constitute a part of this specification, illustrate embodiments according to the disclosure and together with the description serve to explain the principles of the disclosure.

For more clearly illustrating embodiments of the present disclosure, the drawing referred to describe the embodiments will be briefly described hereinafter. Apparently, the drawing in the following description is only an example of the present disclosure, and other drawings may be obtained based on the provided drawings.

FIG. 1 is a structural diagram of a pixel driving circuit according to an embodiment of the present disclosure.

FIG. 2 is a structural diagram of a pixel driving circuit according to an embodiment of the present disclosure.

FIG. 3 is a structural diagram of a pixel driving circuit according to an embodiment of the present disclosure.

FIG. 4 is a structural diagram of a pixel driving circuit according to an embodiment of the present disclosure.

FIG. 5 is a timing sequence diagram of operation of a pixel driving circuit according to an embodiment of the present disclosure.

FIG. 6 is a structural diagram of a pixel driving circuit according to an embodiment of the present disclosure.

FIG. 7 is a structural diagram of a pixel driving circuit according to an embodiment of the present disclosure.

FIG. 8 is a timing sequence diagram of operation of a pixel driving circuit according to an embodiment of the present disclosure.

FIG. 9 is a structural diagram of a pixel driving circuit according to an embodiment of the present disclosure.

FIG. 10 is a timing sequence diagram of operation of a pixel driving circuit according to an embodiment of the present disclosure.

FIG. 11 is a structural diagram of a display panel according to an embodiment of the present disclosure.

FIG. 12 is a structural diagram of a display device according to an embodiment of the present disclosure.

In the drawings, the correspondence between the legends and the components they represent is as follows:
10: amplitude modulation device 11: light emitting element; 12: first transistor; 13: second transistor; 20: pulse width modulation device; T1: first driving transistor; T2: first switch transistor; T3: second switch transistor; T4: second driving transistor; T5: fourth switch transistor; T6: fifth switch transistor; T7: third switch transistor; M1: first data writing transistor; M2: first reset transistor; M3: first compensation transistor; M4: initialization transistor; M5: second data writing transistor; M6: sweeping transistor; M7: second reset transistor; M8: second compensation transistor; M9: clearing transistor; C1: first capacitor; C2: second capacitor; C3: third capacitor; VDD: first power signal terminal; VEE: second power signal terminal; VDD2: turn-off voltage; EMIT1: first light emitting control signal; EMIT2: second light emitting control signal; S1: first scan signal; S2: second scan signal; VREF: reference voltage signal; PAM_DATA: first data writing signal; PWM_DATA: second data writing signal; SWEEP: pulse width control signal; SET: turn-on signal.

### DETAILED DESCRIPTION OF EMBODIMENTS

In order to clarify the above embodiments of the present disclosure, the embodiments of the present disclosure are detailed hereinafter. It should be noted that embodiments of the present disclosure and features in the embodiments may be combined provided they do not conflict with each other.

The following descriptions involve many specific details for thorough understanding of the present disclosure, while in practice the present disclosure may be implemented otherwise. It is apparent that the embodiments in the description are merely some rather than all embodiments of the present disclosure.

In a conventional display panel, a light emitting element is controlled by a pixel driving circuit to emit light. For example, in an OLED, QLED, or Micro LED display panel, the pixel driving circuit includes an amplitude modulation device that can control a magnitude of a driving current by adjusting an amplitude of a driving signal, to control light emitting intensity of the light emitting element. Generally, multiple switch transistors are connected in series in a current driving loop of the amplitude modulation device, and are configured to selectively control the light emitting element to enter a light emitting stage. In practice, different switch transistors have different cross voltages as they are located in different positions in the current driving loop. A switch transistor with a higher cross voltage has a larger turn-on resistance, which causes ineffective power loss to the current driving loop and increasing power consumption of the display panel.

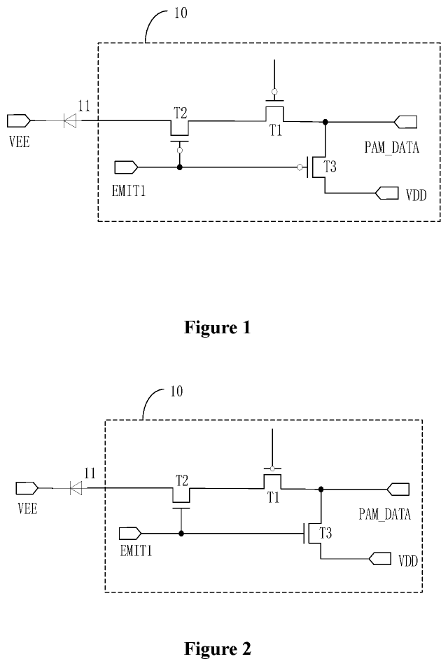

In order to address the above issues, a pixel driving circuit is provided according to an embodiment of the present disclosure. FIG. 1 is a structural diagram of a pixel driving circuit according to an embodiment of the present disclosure. As shown in FIG. 1, the pixel driving circuit includes a light emitting element 11 and an amplitude modulation device 10. The amplitude modulation device 10 includes a first driving transistor T1, a first switch transistor T2 and a second switch transistor T3. The first driving transistor T1 is configured to provide a driving current for the light emitting element 11, and the first switch transistor T2 and the second switch transistor T3 are configured to selectively control the light emitting element 11 to enter a light emitting stage. A width-to-length ratio of a channel of the first switch transistor T2 is different from a width-to-length ratio of a channel of the second switch transistor T3.

In an embodiment of the present disclosure, the amplitude modulation device 10 includes a first driving transistor T1, and the first driving transistor T1 can be turned on according to a potential at a gate (i.e., a control terminal of the first driving transistor T1) of the first driving transistor T1, where a driving current generated based on the turning on is used to driving the light emitting element 11 to emit light. The first driving transistor T1 functions as a driving transistor, and the potential at the gate of the first driving transistor T1 determines a magnitude of the driving current, and luminance of the light emitting element 11 can be adjusted by controlling a gate voltage of the first driving transistor T1, to control gray scale. It should be noted that the gate voltage (i.e., gate potential) of the first driving transistor T1 is a voltage at the control terminal of the first driving transistor T1. The larger the driving current is, the higher the luminance of the light emitting element 11 is. The first switch transistor T2 and the second switch transistor T3 are configured to selectively control the light emitting element 11 to enter a light emitting stage. For example, in order to control the light emitting element to enter the light emitting stage, the first switch transistor T2 and the second switch transistor T3 are turned on under the control of a first light emitting control signal EMIT1, and the current driving loop is turned on to allow the driving current to flow through the light emitting element 11, and the light emitting element 11 enters the light emitting stage to achieve light emitting or display function of the display panel.

For example, as shown in FIG. 1, a loop including the first driving transistor T1, the first switch transistor T2, the second switch transistor T3 and the light emitting element 11 is the current driving loop, where the first driving transistor T1, the first switch transistor T2, the second switch transistor T3 and the light emitting element 11 are connected in series. As the first switch transistor T2 and the second switch transistor T3 are located in different positions of the above current driving loop, the first switch transistor T2 and the second switch transistor T3 correspond to different driving voltages. Since a turn-on resistance and a driving voltage of a transistor are negatively correlated with each other, a switch transistor with a lower driving voltage corresponds to a higher turn-on resistance; as the turn-on resistance is positively correlated with a cross voltage of a transistor, a switch transistor with a higher cross voltage causes ineffective power loss to the current driving loop, to increase power consumption of the display panel.

In the embodiments of the present disclosure, the first switch transistor T2 and the second switch transistor T3 are configured to channels having different width-to-length ratios. The turn-on resistances are adjusted by altering the width-to-length ratios of the channels of the transistors, to adapt to the difference between cross voltages due to different positions, to reduce an overall power consumption of the current driving loop.

It should be noted that the solutions according to the embodiment of the present disclosure can solve power consumption problems of an OLED display panel, and can also be applied to a Micro LED display panel to address power consumption issues thereof. The following embodiments apply to both the OLED and Micro LED display panels, to solve the power consumption problems thereof during the light emitting process.

In some embodiments, the first switch transistor and the second switch transistor may both be P-type transistors. For example, as shown in FIG. 1, the first switch transistor T2 and the second switch transistor T3 are P-type transistors. The first switch transistor T2 is connected in series between the first driving transistor T1 and the light emitting element 11. The second switch transistor T3 is connected in series between the first driving transistor T1 and a first power signal terminal VDD. A cathode of the light emitting element 11 is connected with a second power signal terminal VEE. A voltage of the second power signal terminal VEE is lower than a voltage of the first power signal terminal VDD. That is, the first switch transistor T2 is arranged in a part of the current driving loop including the first driving transistor T1 having a lower voltage, and the second switch transistor T3 is arranged in a part of the current driving loop including the first driving transistor T1 having a higher voltage. The width-to-length ratio of the channel of the first switch transistor T2 is larger than the width-to-length ratio of the channel of the second switch transistor T3.

As the first switch transistor T2 is close to the second power signal terminal VEE, a source voltage Vs of the first switch transistor T2 is low; since the first switch transistor T2 is a P-type transistor, a gate-source voltage of the first switch transistor T2 is Vgs=−|Vgs|=−|Vg|−Vs; as the source voltage Vs of the first switch transistor T2 is low, |Vgs| of the first switch transistor T2 is also low. The second switch transistor T3 is close to the first power signal terminal VDD, and has a high source voltage Vs; therefore, |Vgs| of the second switch transistor T3 is higher than |Vgs| of the first switch transistor, that is, a driving capability of the first switch transistor T2 is weaker. The turn-on resistance of a transistor is given by the following equation:

$$R = \frac{{V}_{DS}}{{I}_{DS}} = \frac{L}{{C}_{OX} \cdot {μ}_{n} \cdot W \cdot ( Vgs - {V}_{T} - 0.5 {V}_{DS} )} ,$$

where R is the turn-on resistance of the transistor, V_{DS} is a voltage between a drain and a source of the transistor, I_{DS} is a current between the drain and the source of the transistor, L is a length of a channel of the transistor, W is a width of the channel of the transistor, Cₒₓ is an accumulation of capacitance in a unit area of the transistor, μₙ is an electron mobility, Vgs is a voltage between a gate and the source of the transistor, i.e., gate-source voltage, and V_{T} is a threshold voltage of turn-on of the transistor.

According to the above equation, at a given width-to-length ratio W/L of the channel of the transistor, the turn-on resistance of the transistor is negatively correlated with the gate-source voltage Vgs of the transistor. Therefore, in a case that the first switch transistor T2 and the second switch transistor T3 are configured with channels having the same width-to-length ratio, the first switch transistor T2 has a higher turn-on resistance, and gets a larger portion of a voltage on the current driving loop including the first driving transistor T1, resulting in useless power consumption and affecting a luminous efficiency of the display panel. To solve the problem, in the embodiment of the present disclosure, the width-to-length ratio of the channel of the first switch transistor T2 is larger than the width-to-length ratio of the channel of the second switch transistor T3, to reduce the turn-on resistance of the first switch transistor T2, to improve the driving capability of the first switch transistor T2, reducing power consumption caused by the first switch transistor T2, and improving the luminous efficiency of the display panel.

In some embodiments, the first switch transistor and the second switch transistor may both be N-type transistors. FIG. 2 is a structural diagram of a pixel driving circuit according to an embodiment of the present disclosure. As shown in FIG. 2, the first switch transistor T2 and the second switch transistor T3 are N-type transistors. The first switch transistor T2 is connected in series between the first driving transistor T1 and the light emitting element 11. The second switch transistor T3 is connected in series between the first driving transistor T1 and the first power signal terminal VDD. The cathode of the light emitting element 11 is connected to the second power signal terminal VEE. The voltage of the second power signal terminal VEE is lower than the voltage of the first power signal terminal VDD. That is, the first switch transistor T2 is arranged in a part of the current driving loop including the first driving transistor T1 having a lower voltage, and the second switch transistor T3 is arranged in a part of the current driving loop including the first driving transistor T1 having a higher voltage. The width-to-length ratio of the channel of the second switch transistor T3 is larger than the width-to-length ratio of the channel of the first switch transistor T2.

As the first switch transistor T2 is close to the second power signal terminal VEE, the source voltage Vs of the first switch transistor T2 is low; since the first switch transistor T2 is an N-type transistor, the gate-source voltage of the first switch transistor T2 is Vgs=|Vgs|=Vg−Vs; as the source voltage Vs of the first switch transistor T2 is low, |Vgs| of the first switch transistor T2 is high. The second switch transistor T3 is close to the first power signal terminal VDD, and has a high source voltage Vs; therefore, the gate-source voltage Vgs of the second switch transistor T3 is lower than the gate-source voltage Vgs of the first switch transistor, that is, a driving capability of the second switch transistor T3 in this circuit is weaker.

According to the above equation giving the turn-on resistance of a transistor, at a given width-to-length ratio W/L of the channel of the transistor, the turn-on resistance of the transistor is negatively correlated with the gate-source voltage Vgs of the transistor. Therefore, in a case that the first switch transistor T2 and the second switch transistor T3 are configured with channels having the same width-to-length ratio, the second switch transistor T3 has a higher turn-on resistance, and gets a larger portion of the voltage on the current driving loop including the first driving transistor T1, resulting in useless power consumption and affecting the luminous efficiency of the display panel. To solve the problem, in the embodiment of the present disclosure, the width-to-length ratio of the channel of the second switch transistor T3 is larger than the width-to-length ratio of the channel of the first switch transistor T2, to reduce the turn-on resistance of the second switch transistor T3, to improve the driving capability of the second switch transistor T3, reducing power consumption caused by the second switch transistor T3, and improving the luminous efficiency of the display panel.

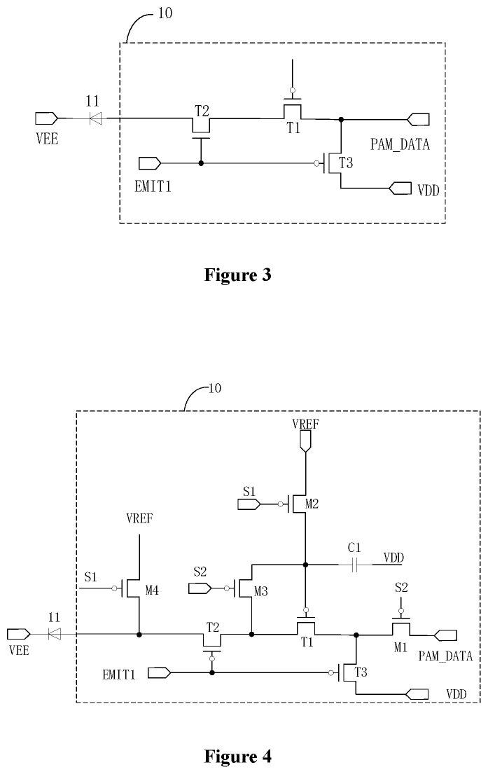

FIG. 3 is a structural diagram of a pixel driving circuit according to an embodiment of the present disclosure. As shown in FIG. 3, the first switch transistor T2 is an N-type transistor, and the second switch transistor T3 is a P-type transistor. The first switch transistor T2 is connected in series between the first driving transistor T1 and the light emitting element 11. The second switch transistor T3 is connected in series between the first driving transistor T1 and the first power signal terminal VDD. The cathode of the light emitting element 11 is connected to the second power signal terminal VEE. The width-to-length ratio of the channel of the second switch transistor T3 is larger than the width-to-length ratio of the channel of the first switch transistor T2.

In an embodiment of the present disclosure, the first switch transistor T2 and the second switch transistor T3 are different types of transistors. For example, the first switch transistor T2 is an N-type transistor, and the second switch transistor T3 is a P-type transistor. The first switch transistor T2 is an N-type transistor, and is turned on when a voltage difference between the gate and the source thereof is higher than a threshold voltage, i.e., turned on at a high level. The second switch transistor T3 is a P-type transistor, and is turned on when a voltage difference between the gate and the source thereof is lower than the threshold voltage, i.e., turned on at a low level.

As the first switch transistor T2 is arranged in the part of the current driving loop including the first driving transistor having a lower voltage, the source voltage Vs of the first switch transistor T2 is lower. In order to enable the first switch transistor T2 with a high driving capability, i.e., with a high |Vgs|, the first switch transistor T2 is configured to be an N-type transistor.

As the second switch transistor T3 is arranged in the part of the current driving loop including the first driving transistor having a higher voltage, the source voltage Vs of the second switch transistor T3 is higher. In order to enable the second switch transistor T3 with a high driving capability, i.e., with a high |Vgs|, the second switch transistor T3 is configured to be a P-type transistor.

In addition, an N-type transistor has electron carriers, a P-type transistor has hole carriers, and a movement velocity of the hole carrier is less than that of the electron carrier. The first switch transistor T2 is an N-type transistor, and the second switch transistor T3 is a P-type transistor; therefore, in an embodiment of the present disclosure, the width-to-length ratio of the channel of the second switch transistor T3 is configured to be larger than the width-to-length ratio of the channel of the first switch transistor T2, to improving the driving capability of the second switch transistor T3.

It should be noted that in the embodiments of the present disclosure, the pixel driving circuit may include other elements essential for driving the light emitting element to emit light, such as transistors and capacitors. The numbers, positions and connections of other transistors and capacitors are not limited in the embodiments of the present disclosure. Exemplary description thereof is given with reference to FIG. 4, which is a structural diagram of a pixel driving circuit according to an embodiment of the present disclosure. As shown in FIG. 4, in some embodiments, the amplitude modulation device further includes a first data writing transistor M1, a first capacitor C1, a first reset transistor M2, a first compensation transistor M3 and an initialization transistor M4.

A control terminal of the first data writing transistor M1 is configured to receive a second scan signal S2, a first terminal of the first data writing transistor M1 is configured to receive a first data writing signal PAM_DATA, and a second terminal of the first data writing transistor M1 is electrically connected to a first terminal of the first driving transistor T1.

A control terminal of the first reset transistor M2 is configured to receive a first scan signal S1, a first terminal of the first reset transistor M2 is configured to receive a reference voltage signal VREF, and a second terminal of the first reset transistor M2 is electrically connected to the control terminal of the first driving transistor T1.

A control terminal of the first compensation transistor M3 is configured to receive the second scan signal S2, a first terminal of the first compensation transistor M3 is electrically connected to a second terminal of the first driving transistor T1, and a second terminal of the first compensation transistor M3 is electrically connected to the control terminal of the first driving transistor T1.

A control terminal of the initialization transistor M4 is configured to receive the first scan signal, a first terminal of the initialization transistor M4 is configured to receive the reference voltage signal VREF, and a second terminal of the initialization transistor M4 is electrically connected with an anode of the light emitting element 11.

A first electrode of the first capacitor C1 is electrically connected with the first power signal terminal VDD, and a second electrode of the first capacitor C1 is electrically connected with the control terminal of the first driving transistor T1.

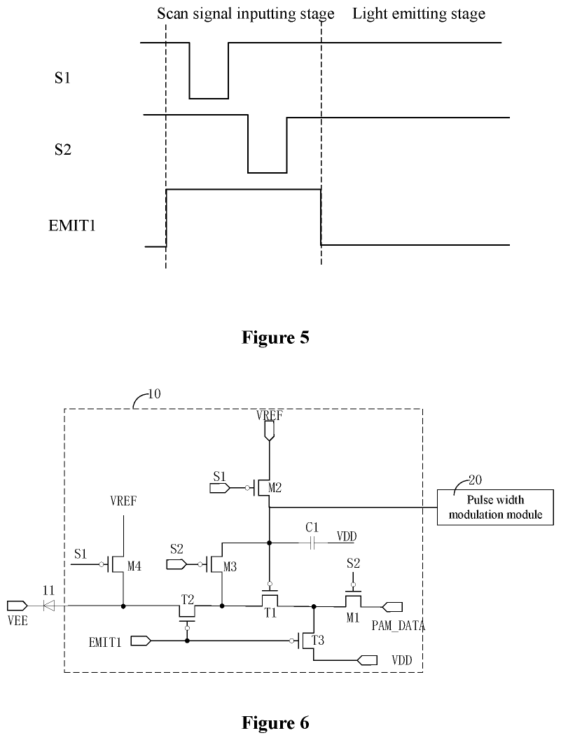

The operation of the pixel driving circuit is explained, with each of the transistors being a P-type transistor for example. FIG. 5 is a timing sequence diagram of operation of a pixel driving circuit according to an embodiment of the present disclosure. The operation of the pixel driving circuit is described in detail with reference to FIGS. 4 and 5. As shown in FIG. 5, one frame period consists of a scan signal inputting stage and a light emitting stage.

In the scan signal inputting stage, the first light emitting control signal EMIT1 is at a high level.

A low level signal is inputted as the first scan signal S1, and the first reset transistor M2 is turned on to transmit the reference voltage signal VREF to the control terminal of the first driving transistor T1 (the control terminal is the gate thereof, and therefore the gate voltage is a voltage at the control terminal). At this time, the gate voltage of the first driving transistor T1 is VREF, which resets the control terminal of the first driving transistor T1. At the same time, the first scan signal S1 also turns on the initialization transistor M4 to transmit the reference voltage signal VREF to the anode of the light emitting element 11, to reset the anode of the light emitting element 11.

It should be noted that the reference voltage signal VREF transmitted to the control terminal of the first driving transistor T1 and the reference voltage signal VREF transmitted to the anode of the light emitting element 11 may have different values. In an embodiment, a voltage of the reference voltage signal transmitted to the control terminal of the first driving transistor T1 is lower than a voltage of the reference voltage signal transmitted to the anode of the light emitting element 11. For example, the voltage of the reference voltage signal transmitted to the control terminal of the first driving transistor T1 is −5.3V, and the voltage of the reference voltage signal transmitted to the anode of the light emitting element 11 is −3V.

After enabling of the first scan signal S1 finishes, a low level signal is inputted as the second scan signal S2, to turn on the first data writing transistor M1 and transmit the first data writing signal PAM_DATA to a source of the first driving transistor T1. At this time, the first compensation transistor M3 is turned on in a synchronized manner, and a drain and the gate of the first driving transistor T1 form a loop, where the gate voltage of the first driving transistor T1 changes to PAM_DATA+Vth. The first capacitor C1 is configured to maintain a potential at the control terminal of the first driving transistor T1.

After enabling of the second scan signal S2 finishes, a low level signal is inputted as the first light emitting control signal EMIT1. Whilst the first light emitting control signal EMIT1 is a low level signal, the first switch transistor T2 and the second switch transistor T3 are turned on, and a driving current, generated by the first driving transistor T1 with the first power signal terminal VDD according to the first data writing signal PAM_DATA, flows through the light emitting element 11 to the second power signal terminal VEE, and the light emitting element 11 emits light. A magnitude of the driving current of the first driving transistor T1 can be adjusted by adjusting the first data writing signal PAM_DATA, to control the light emitting intensity of the light emitting element 11.

In some embodiments, the pixel driving circuit includes an amplitude modulation device, and the amplitude modulation device is configured to selectively control a light emitting intensity of a light emitting element. The amplitude modulation device includes a first driving transistor, a first switch transistor, a second switch transistor and the light emitting element. The first driving transistor is configured to provide a driving current for the light emitting element, and the first switch transistor and the second switch transistor are configured to selectively control the light emitting element to enter a light emitting stage.

A width-to-length ratio of a channel of at least one of the first switch transistor, the second switch transistor and the first driving transistor is larger than a width-to-length ratio of a channel of a first transistor. The first transistor is a transistor other than the first switch transistor, the second switch transistor and the first driving transistor. That is, the first transistor is a transistor in the pixel driving circuit, other than the first switch transistor, the second switch transistor and the first driving transistor.

For example, as shown in FIG. 4, as the current driving loop including the first driving transistor T1 needs a large driving current for the light emitting element to emit light, the width-to-length ratio of the channel of at least one of the first switch transistor T2, the second switch transistor T3 and the first driving transistor T1 is larger than the width-to-length ratio of the channel of the first transistor in the embodiment of the present disclosure, to reduce a turn-on resistance of at least one of the first switch transistor T2, the second switch transistor T3 and the first driving transistor T1, to reduce power consumption caused by a turn-on resistance of the transistors in the current driving loop.

Exemplarily, continuing with FIG. 4, the above first transistor includes at least one of the first data writing transistor, the first compensation transistor, the first reset transistor or the initialization transistor, for example. The first transistor according to the embodiment of the present disclosure may be any transistor other than the first switch transistor T2, the second switch transistor T3 and the first driving transistor T1.

In some embodiments, the pixel driving circuit includes a light emitting element and an amplitude modulation device. The amplitude modulation device includes a first driving transistor, a first switch transistor, and a second switch transistor. The first driving transistor is configured to provide a driving current for the light emitting element, and the first switch transistor and the second switch transistor are configured to selectively control the light emitting element to enter a light emitting stage.

Width-to-length ratios of channels of the first switch transistor, the second switch transistor and the first driving transistor are all larger than the width-to-length ratio of the channel of the first transistor. The first transistor is a transistor other than the first switch transistor, the second switch transistor and the first driving transistor.

For example, as shown in FIG. 4, as the first switch transistor T2, the second switch transistor T3 and the first driving transistor T1 are all in the current driving loop, the current driving loop needs a large driving current for the light emitting element to emit light. In order to reduce power consumption caused by turn-on resistances of the first switch transistor T2, the second switch transistor T3 and the first driving transistor T1, the width-to-length ratios of the channels of the first switch transistor T2, the second switch transistor T3 and the first driving transistor T1 are all configured to be larger than the width-to-length ratio of the channel of the first transistor in the embodiment of the present disclosure.

In some embodiments of the present disclosure, the width-to-length ratio of the channel of the first switch transistor is larger than the width-to-length ratio of the channel of the first driving transistor; and/or

the width-to-length ratio of the channel of the second switch transistor is larger than the width-to-length ratio of the channel of the first driving transistor.

Continuing with FIG. 4 for example, in an embodiment, the width-to-length ratio of the channel of the first switch transistor T2 is larger than the width-to-length ratio of the channel of the first driving transistor T1. The first driving transistor T1 is configured to provide a driving current for the light emitting element 11, and upon the control terminal of the first driving transistor T1 receives a turn-on signal, it is conductive between the first terminal and the second terminal of the first driving transistor, and the driving current in the current driving loop can flow to the light emitting element 11, to provide the driving current for the light emitting element 11. The first switch transistor T2 is configured to selectively control the light emitting element 11 to enter a light emitting stage. For example, to control the light emitting element 11 to enter the light emitting stage, the first light emitting control signal EMIT1 controls the first switch transistor T2 to turn on, and the driving current generated by the first driving transistor T1 can be transmitted to the light emitting element 11 to drive the light emitting element 11 to emit light. Therefore, the driving capability of the first switch transistor T2 needs to be higher than that of the first driving transistor T1, and the driving current provided by the first driving transistor T1 can completely flow through the first switch transistor T2 and be transmitted to the light emitting element 11 after the first switch transistor T2 is turned on. Therefore, the width-to-length ratio of the channel of the first switch transistor T2 is configured to be larger than the width-to-length ratio of the channel of the first driving transistor T1 in an embodiment of the present disclosure, and the turn-on resistance of the first switch transistor T2 is lower than that of the first driving transistor T1, to improve the driving capability of the first switch transistor T2.

The width-to-length ratio of the channel of the second switch transistor T3 is larger than the width-to-length ratio of the channel of the first driving transistor T1. Similar to the above, the first driving transistor T1 is configured to provide a driving current for the light emitting element 11. The second switch transistor T3 is configured to selectively control the light emitting element 11 to enter a light emitting stage. For example, to control the light emitting element 11 to enter the light emitting stage, the driving current generated by the first driving transistor T1 is transmitted to the light emitting element 11 to drive the light emitting element 11 to emit light. Therefore, the driving capability of the second switch transistor T3 needs to be higher than that of the first driving transistor T1, and a voltage provided at the first power signal terminal VDD can be transmitted to the light emitting element 11 through the second switch transistor T3, after the second switch transistor T3 is turned on. Therefore, the turn-on resistance of the second switch transistor T3 needs to be lower than that of the first driving transistor T1. Therefore, the width-to-length ratio of the channel of the second switch transistor T3 is configured to be larger than the width-to-length ratio of the channel of the first driving transistor T1 in an embodiment of the present disclosure, to improve the driving capability of the second switch transistor T3.

In an embodiment, the width-to-length ratio of the channel of the first switch transistor T2 may be configure to be larger than the width-to-length ratio of the channel of the first driving transistor T1, and the width-to-length ratio of the channel of the second switch transistor T3 may also be configure to be larger than the width-to-length ratio of the channel of the first driving transistor T1. In an embodiment of the present disclosure, the width-to-length ratios of the channels of the first switch transistor T2 and the second switch transistor T3 are both larger than the width-to-length ratio of the channel of the first driving transistor T1; hence, the turn-on resistances of the first switch transistor T2 and the second switch transistor T3 are both higher than that of the first driving transistor T1, and the driving capabilities of the first switch transistor T2 and the second switch transistor T3 are both improved.

In some embodiments, a length of the channel of the first driving transistor is larger than a length of a channel of any other transistor in the amplitude modulation device.

The first driving transistor is configured to provide a driving current for the light emitting element, and therefore stability of the first driving transistor should be ensured. A length of a channel of a transistor influences properties of the transistor, where the larger the length of the channel is, the higher the stability and uniformity of the transistor are and the weaker the short channel effect and tunneling effect are. With higher stability, current leakage issues can be alleviated. In a case that the length of the channel is small, a probability that a source and a drain in one metal pattern layer are short-circuited is increased. To ensure that the source and drain can effectively draw a current from the channel, the length of the channel of the first driving transistor is configured to be larger than the length of channel of any other transistor in the amplitude modulation device in an embodiment of the present disclosure. In this way, it is ensured that the source and drain can effectively draw a current from the channel, and the stability of the first driving transistor is improved.

In some embodiments, the channel of the first driving transistor may be configured to have a large length, to ensure the stability of the first driving transistor. Accordingly, the channel of the first driving transistor may be configured to have a small width-to-length ratio, that is, the width-to-length ratio of the channel of the first driving transistor may be smaller than a width-to-length ratio of the channel of any other transistor in the amplitude modulation device.

In some embodiments, the pixel driving circuit includes a light emitting element and an amplitude modulation device, and the amplitude modulation device includes a first driving transistor, a first switch transistor and a second switch transistor. The first driving transistor is configured to provide a driving current for the light emitting element, and the first switch transistor and the second switch transistor are configured to selectively control the light emitting element to enter a light emitting stage. The pixel driving circuit further includes a pulse width modulation device configured to control a light emitting duration of the light emitting element. FIG. 6 is a structural diagram of a pixel driving circuit according to an embodiment of the present disclosure. As shown in FIG. 6, the pulse width modulation device 20 is configured to control a light emitting duration of the light emitting element 11, and is electrically connected with the amplitude modulation device 10. In the embodiments of the present disclosure, the magnitude of the driving current and the light emitting duration affect a luminance of a light emitting unit. By adjusting the magnitude of the driving current with the amplitude modulation device 10 and adjusting the light emitting duration of the light emitting element with the pulse width modulation device 20, the luminance of the light emitting element 11 can be controlled.

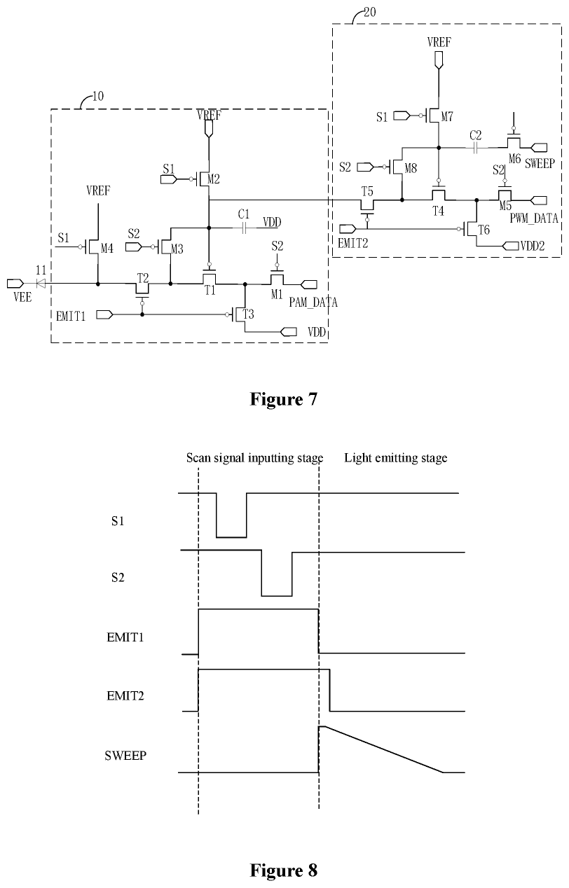

In some embodiments, the pixel driving circuit includes a light emitting element and an amplitude modulation device, and the amplitude modulation device includes a first driving transistor, a first switch transistor and a second switch transistor. The first driving transistor is configured to provide a driving current for the light emitting element, and the first switch transistor and the second switch transistor are configured to selectively control the light emitting element to enter a light emitting stage. The pixel driving circuit further includes a pulse width modulation device configured to control a light emitting duration of the light emitting element. FIG. 7 is a structural diagram of a pixel driving circuit according to an embodiment of the present disclosure. As shown in FIG. 7, the pulse width modulation device 20 includes a second driving transistor T4. The second driving transistor T4 is configured to provide, according to a potential at a control terminal of the second driving transistor T4, a turn-off voltage VDD2 to the current driving loop including the first driving transistor T1, to control a turn-on duration of the current driving loop including the first driving transistor T1.

The width-to-length ratio of the channel of the first driving transistor T1 is larger than a width-to-length ratio of a channel of the second driving transistor T4.

In an embodiment of the present disclosure, the second driving transistor T4 is configured to provide, according to the potential at the control terminal of the second driving transistor T4, the turn-off voltage VDD2 to the current driving loop including the first driving transistor T1, to control the turn-on duration of the current driving loop including the first driving transistor T1 and to control the light emitting duration of the light emitting element 11. The first driving transistor T1 is configured to provide a driving current for the light emitting element 11, and the second driving transistor T4 is configured to provide a potential for the current driving loop including the first driving transistor T1, which functions as a switch. Therefore, the first driving transistor T1 needs a high driving capability, to drive the light emitting element. In the current driving loop, by configuring the first driving transistor T1 with a channel having a large width-to-length ratio, the turn-on resistance of the first driving transistor T1, as well as power consumption on the turn-on resistance of the first driving transistor T1 in the current driving loop, can be reduced.

In some embodiments, the pixel driving circuit includes a light emitting element and an amplitude modulation device, and the amplitude modulation device includes a first driving transistor, a first switch transistor and a second switch transistor. The first driving transistor is configured to provide a driving current for the light emitting element, and the first switch transistor and the second switch transistor are configured to selectively control the light emitting element to enter a light emitting stage. The pixel driving circuit further includes a pulse width modulation device configured to control a light emitting duration of the light emitting element. For example, as shown in FIG. 7, the amplitude modulation device 10 includes a first capacitor C1, and the pulse width modulation device 20 includes a second capacitor C2. The first capacitor C1 is electrically connected with the control terminal of the first driving transistor t1, and the second capacitor C2 is electrically connected to the control terminal of the second driving transistor T4, where a capacitance of the second capacitor C2 is smaller than a capacitance of the first capacitor C1.

A first electrode of the first capacitor C1 is electrically connected with the first power signal terminal VDD, and a second electrode of the first capacitor C1 is electrically connected with the control terminal of the first driving transistor T1. A first electrode of the second capacitor C2 is electrically connected with the control terminal of the second driving transistor T4, and a second electrode of the second capacitor C2 is configured to receive a pulse width control signal SWEEP. The first capacitor C1 and the second capacitor C2 are both storage capacitors. The second driving transistor T4 is configured to provide a potential for the current driving loop including the light emitting element 11, to control the light emitting duration of the light emitting element 11. The first driving transistor T1 is configured to provide a driving current for the current driving loop including the light emitting element 11. Therefore, the width-to-length ratio of the channel of the second driving transistor T4 in the pulse width modulation device 20 is generally smaller than the width-to-length ratio of the channel of the first driving transistor T1 in the amplitude modulation device 10. Since the width-to-length ratio of the channel of the second driving transistor T4 is smaller, a parasite capacitance (such as a parasite capacitance between a gate and a source, and a parasite capacitance between the gate and a drain) caused by the second driving transistor T4 is smaller than a parasite capacitance caused by the first driving transistor T1, which has smaller influence on the potential at the control terminal of the second driving transistor T4. As such, the capacitance of the second capacitor C2 for voltage stabilization of the control terminal of the second driving transistor T4 may be configured to be smaller than the capacitance of the first capacitor C1 for stabilization of the control terminal of the first driving transistor T1, that is, the capacitance of the second capacitor C2 is smaller than the capacitance of the first capacitor C1. It should be noted that if the storage capacitors include dielectric layers made of the same material, a capacitance may be reduced by reducing an area of the capacitor, to reduce space occupied by an overall circuit.

In some embodiments, the pixel driving circuit includes a light emitting element and an amplitude modulation device, and the amplitude modulation device includes a first driving transistor, a first switch transistor and a second switch transistor. The first driving transistor is configured to provide a driving current for the light emitting element, and the first switch transistor and the second switch transistor are configured to selectively control the light emitting element to enter a light emitting stage. The pixel driving circuit further includes a pulse width modulation device configured to control a light emitting duration of the light emitting element. The pulse width modulation device includes a second driving transistor. The second driving transistor is configured to provide, according to a potential at a control terminal of the second driving transistor, a turn-off voltage to the control terminal of the first driving transistor.

For example, as shown in FIG. 7, a first terminal of the second driving transistor T4 is configured to receive the turn-off voltage VDD2, a second terminal of the second driving transistor T4 is connected with the control terminal of the first driving transistor T1 in the amplitude modulation device 10, and the control terminal of the second driving transistor T4 is configured to receive the pulse width control signal SWEEP. The second driving transistor T4 switches between on and off under the control of the pulse width control signal SWEEP. When a potential of the pulse width control signal SWEEP turns on the second driving transistor T4, the turn-off voltage VDD2 is transmitted to the control terminal of the first driving transistor T1 through the second driving transistor T4, to control a turn-on duration of the current driving loop including the first driving transistor T1. It should be noted that this embodiment only describes one feasible implementation, and the specific structure of the current driving loop including the first driving transistor is not limited in the present disclosure.

In some embodiments, the pixel driving circuit includes a light emitting element and an amplitude modulation device, and the amplitude modulation device includes a first driving transistor, a first switch transistor and a second switch transistor. The first driving transistor is configured to provide a driving current for the light emitting element, and the first switch transistor and the second switch transistor are configured to selectively control the light emitting element to enter a light emitting stage. The pixel driving circuit further includes a pulse width modulation device configured to control a light emitting duration of the light emitting element. Continuing with FIG. 7, the amplitude modulation device 10 includes a first data writing transistor M1, and the first data writing transistor M1 selectively provides a first data writing signal PAM_DATA for the control terminal of the first driving transistor T1.

The pulse width modulation device 20 further includes a second data writing transistor T5, and the second data writing transistor T5 selectively provides a second data writing signal PWM_DATA for the control terminal of the second driving transistor T4.

A width-to-length ratio of a channel of the first data writing transistor M1 is smaller than or equal to a width-to-length ratio of a channel of the second data writing transistor M5.

Exemplarily, in the pixel driving circuit according to an embodiment of the present disclosure, the amplitude modulation device 10 further includes a first data writing transistor M1. The first terminal of the first data writing transistor M1 receives the first data writing signal PAM_DATA, and the control terminal of the first data writing transistor M1 receives the second scan signal S2. When the second scan signal is inputted into the control terminal of the first data writing transistor M1 and turns on the first data writing transistor M1, the first data writing signal PAM_DATA is written into the control terminal of the first driving transistor T1 through the first data writing transistor M1. The pulse width modulation device further includes a second data writing transistor M5, where a first terminal of the second data writing transistor M5 receives the second data writing signal PWM_DATA, and a control terminal of the second data writing transistor M5 receives the second scan signal S2. When the second scan signal is inputted into the control terminal of the second data writing transistor M5 and turns on the second data writing transistor M5, the second data writing signal PWM_DATA is written into the control terminal of the second driving transistor T4 through the second data writing transistor M5.

As the amplitude modulation device 10 can simultaneously write multiple rows of data of a frame during data writing, it has a low requirement on writing speed. By contrast, as the pulse width modulation device 20 writes data row by row during data writing, the requirement on a data writing speed of the second data writing transistor M5 is high. The larger a width-to-length ratio of a channel of a data writing transistor is, the faster the data writing thereof is. Therefore, the width-to-length ratio of the channel of the second data writing transistor M5 may be configured to be larger than the width-to-length ratio of the channel of the first data writing transistor M1, to improve a data writing speed of the pulse width modulation device 20.

In some embodiments, the pixel driving circuit includes a light emitting element and an amplitude modulation device, and the amplitude modulation device includes a first driving transistor, a first switch transistor and a second switch transistor. The first driving transistor is configured to provide a driving current for the light emitting element, and the first switch transistor and the second switch transistor are configured to selectively control the light emitting element to enter a light emitting stage. The pixel driving circuit further includes a pulse width modulation device configured to control a light emitting duration of the light emitting element. The pulse width modulation device includes a second data writing transistor. The second data writing transistor is configured to selectively provide a second data writing signal for the control terminal of the second driving transistor. The width-to-length ratio of the channel of the second data writing transistor is smaller than or equal to the width-to-length ratio of the channel of the second driving transistor.

Continuing with FIG. 7 for example, the pulse width modulation device 20 includes a second data writing transistor M5 and a second driving transistor T4. The first terminal of the second data writing transistor M5 receives the second data writing signal PWM_DATA, the second terminal of the second data writing transistor M5 is electrically connected with the second driving transistor T4, and the control terminal of the second data writing transistor M5 receives the second scan signal S2. When the second scan signal S2 is inputted into the control terminal of the second data writing transistor M5 and turns on the second data writing transistor M5, the second data writing signal PWM_DATA is written into the control terminal of the second driving transistor T4 through the second data writing transistor M5.

In the pulse width modulation device 20, the second driving transistor T4 is configured to provide, according to the potential at the control terminal of the second driving transistor T4, the turn-off voltage VDD2 to the current driving loop including the first driving transistor T1, to control the turn-on duration of the current driving loop including the first driving transistor T1. Therefore, the driving capability of the second driving transistor T4 should be ensured. As such, the width-to-length ratio of the channel of the second driving transistor T4 should meet some conditions. On this basis, in order to reduce space occupied by the transistors, the width-to-length ratio of the channel of the second data writing transistor M5 may be configured to be smaller than the width-to-length ratio of the channel of the second driving transistor T4, to reduce the space occupied by the circuits.

In some embodiments, the pixel driving circuit includes a light emitting element and an amplitude modulation device, and the amplitude modulation device includes a first driving transistor, a first switch transistor and a second switch transistor. The first driving transistor is configured to provide a driving current for the light emitting element, and the first switch transistor and the second switch transistor are configured to selectively control the light emitting element to enter a light emitting stage. The pixel driving circuit further includes a pulse width modulation device configured to control a light emitting duration of the light emitting element. With reference to FIG. 7, the pulse width modulation device 20 further includes a sweeping transistor M6. The sweeping transistor M6 is configured to transmit the pulse width control signal SWEEP to the control terminal of the second driving transistor T4. A width-to-length ratio of a channel of the sweeping transistor M6 is smaller than or equal to the width-to-length ratio of the channel of the second driving transistor T4.

The pulse width modulation device 20 further includes a sweeping transistor M6. A first terminal of the sweeping transistor M6 receives the pulse width control signal SWEEP, and a second terminal of the sweeping transistor M6 is electrically connected with the control terminal of the second driving transistor T4. Thus, when the sweeping transistor M6 is turned on, the pulse width control signal SWEEP can be transmitted to the control terminal of the second driving transistor T4 through the sweeping transistor, to control a timing sequence of the pulse width control signal SWEEP. The second driving transistor T4 is a transistor for the purpose of control, and needs sufficient driving capability. Therefore, the second driving transistor T4 has a channel with a large enough width-to-length ratio, to reduce the turn-on resistance of the transistor and improving the driving capability of the second driving transistor T4. The sweeping transistor only controls the timing sequence of the pulse width control signal and does not need high driving capability. In order to save space occupied by the resistors, the width-to-length ratio of the channel of the sweeping transistor is smaller than or equal to the width-to-length ratio of the channel of the second driving transistor.

It should be noted that in the embodiments of the present disclosure, the pixel driving circuit may include other elements essential for driving the light emitting element to emit light, such as transistors and capacitors. The numbers, positions and connections of other transistors and capacitors are not limited in the embodiments of the present disclosure.

The numbers, positions and connections of other transistors and capacitors are not limited in the embodiments of the present disclosure. Exemplary description is given with reference to FIG. 7 hereinafter. In some embodiments, the pixel driving circuit may further include a second data writing transistor M5, a second capacitor C2, a second reset transistor M7 and a second compensation transistor M8.

The control terminal of the second data writing transistor M5 is configured to receive the second scan signal S2, the first terminal of the second data writing transistor M5 is configured to receive the second data writing signal PWM_DATA, and the second terminal of the second data writing transistor M5 is electrically connected with the first terminal of the second driving transistor T4.

A control terminal of the second reset transistor M7 is configured to receive the first scan signal S1, a first terminal of the second reset transistor M7 is configured to receive the reference voltage signal VREF, and a second terminal of the second reset transistor M7 is electrically connected with the control terminal of the second driving transistor T4.

A control terminal of the second compensation transistor M8 is configured to receive the second scan signal S2, a first terminal of the second compensation transistor M8 is electrically connected with the second terminal of the second driving transistor T4, and a second terminal of the second compensation transistor M8 is electrically connected with the control terminal of the second driving transistor T4.

The first electrode of the second capacitor C2 is electrically connected with the control terminal of the second driving transistor T4, and the second electrode of the second capacitor C2 is configured to receive the pulse width control signal SWEEP.

FIG. 8 is a timing sequence diagram of a pixel driving circuit according to an embodiment of the present disclosure. An operation principle of the pixel driving circuit is elaborated with reference to the pixel driving circuit shown in FIG. 7 and the timing sequence diagram shown in FIG. 8.

As shown in FIG. 7, the transistors are P-type transistors. Since a P-type transistor is turned on when a voltage difference between a gate and a source thereof is lower than a threshold voltage, i.e., turned on at a low lever, the pulse width control signal SWEEP may be configured to fall linearly (as shown in FIG. 8). As the control terminal of the second driving transistor T4 is connected with the first electrode of the second capacitor, a voltage at the control terminal of the second driving transistor T4 will change at a slope the same as a slope of linear change of SWEEP from an initial voltage when the pulse width control signal SWEEP is inputted into the second electrode of the second capacitor C2, until it becomes lower than a threshold voltage of the second driving transistor T4 to turn on the second driving transistor T4, and the turn-off voltage VDD2 is transmitted to the control terminal of the first driving transistor T1 through the second driving transistor T4, and the first driving transistor T1 stops outputting a driving current to the light emitting element 11 under the control of the turn-off voltage VDD2. As can be seen from the above process, the light emitting duration of the light emitting element 11 is controlled by the first data writing signal PAM_DATA and the pulse width control signal SWEEP. The pixel driving circuit further includes a fourth switch transistor T5 and a fifth switch transistor T6, and the fourth switch transistor T5 and the fifth switch transistor T6, under the control of the second light emitting control signal EMIT2, controls whether the turn-off signal VDD2 is transmitted to the control terminal of the first driving transistor T1.

As shown in FIG. 8, one frame period consists of a scan signal inputting stage and a light emitting stage.

In the scan signal inputting stage, the first light emitting control signal EMIT1 is at a high level.

A low level signal is inputted as the first scan signal S1, and the first reset transistor M2 is turned on to transmit the reference voltage signal VREF to the control terminal of the first driving transistor T1. At this time, the gate voltage of the first driving transistor T1 is VREF, which resets the control terminal of the first driving transistor T1. At the same time, the first scan signal S1 also turns on the initialization transistor M4 to transmit the reference voltage signal VREF to the light emitting element 11, to reset the light emitting element 11. The first scan signal S1 is written into the second reset transistor M7, and the second reset transistor M7 is turned on, to transmit the reference voltage signal VREF to the control terminal of the second driving transistor T4. At this time, the voltage at the control terminal of the second driving transistor T4 is VREF, which resets the control terminal of the second driving transistor T4.

After enabling of the first scan signal S1 finishes, a low level signal is inputted as the second scan signal S2, to turn on the first data writing transistor M1 and transmit the first data writing signal PAM_DATA to the source of the first driving transistor T1. At this time, the first compensation transistor M3 is turned on in a synchronized manner, and the drain and the gate of the first driving transistor T1 form a loop, where the gate voltage of the first driving transistor T1 changes to PAM_DATA+Vth. FIG. 7 exemplarily shows that both the control terminals of the first data writing transistor M1 and the first compensation transistor M3 receive S2, that is, the first data writing transistor M1 and the first compensation transistor M3 use the same scan signal. In other embodiments, the first data writing transistor M1 and the first compensation transistor M3 may be configured with different scan signals, as long as effective levels of the scan signals of the first data writing transistor M1 and the first compensation transistor M3 at least partly overlap with each other. The second scan signal S2 is also written into the second data writing transistor M5, and at this time, the second data writing transistor M5 is turned on, to transmit the second data writing signal PWM_DATA to a source of the second driving transistor T4. At this time, the second compensation transistor M8 is turned on in a synchronized manner, and a drain and a gate of the second driving transistor T4 form a loop, to compensate for the voltage at the control terminal of the second driving transistor T4.

After enabling of the second scan signal S2 finishes, the pulse width control signal SWEEP changes linearly (for example, falls linearly), and a low level signal is inputted as the first light emitting control signal EMIT1. Whilst the first light emitting control signal EMIT1 is a low level signal, the first switch transistor T2 and the second switch transistor T3 are turned on, and a driving current, generated by the first driving transistor T1 with the first power signal terminal VDD according to the first data writing signal PAM_DATA, flows through the light emitting element 11 to the second power signal terminal VEE, and the light emitting element 11 emits light. The turn-on duration of the first driving transistor T1 can be adjusted by adjusting the first data writing signal PAM_DATA, to control the magnitude of the current for the light emitting element 11.

At the same time, a low level signal is inputted as the second light emitting control signal EMIT2. Whilst the second light emitting control signal EMIT2 is a low level signal, the fourth switch transistor T5 and the fifth switch transistor T6 are turned on, which enables a pulse width modulation function and transmits the turn-off voltage VDD2 to the control terminal of the second driving transistor T4, and the second driving transistor T4 provides, according to the potential at the control terminal of the second driving transistor T4, the turn-off voltage VDD2 to the control terminal of the first driving transistor T1. The potential at the control terminal of the second driving transistor T4 changes at the slope the same as the slope of linear change of the pulse width control signal SWEEP, until it is lower than Vth, and the second driving transistor T4 transforms from a high-impedance state to a conductive state, and the turn-off voltage VDD2 is provided to the control terminal of the first driving transistor T1. The first driving transistor T1 transforms from a conductive state to a high-impedance state under the control of the turn-off voltage VDD2, and stops outputting a driving current to the light emitting element 11. Thus, the turn-on duration of the first driving transistor T1 is controlled by the second data writing signal PWM_DATA and the pulse width control signal SWEEP combined, to control the light emitting duration of the light emitting element 11.

It should be noted that the transistors in the embodiments of the present disclosure may be configured as N-type transistors alternatively. In a case that the transistors are N-type transistors, the pulse width control signal SWEEP may be configured to rise linearly, as an N-type transistor is turned on when a voltage difference between a gate and a source thereof is higher than a threshold voltage, i.e., turned on at a high level. Similar to the operation principle in the above embodiment, the transistors are reset by the first scan signal S1, and multiple transistors are turned on under the control of the second scan signal S2, and the driving transistors are turned on, and the light emitting duration of the light emitting element 11 and the magnitude of the driving current are controlled by the first light emitting control signal EMIT1 and the second light emitting control signal EMIT2.

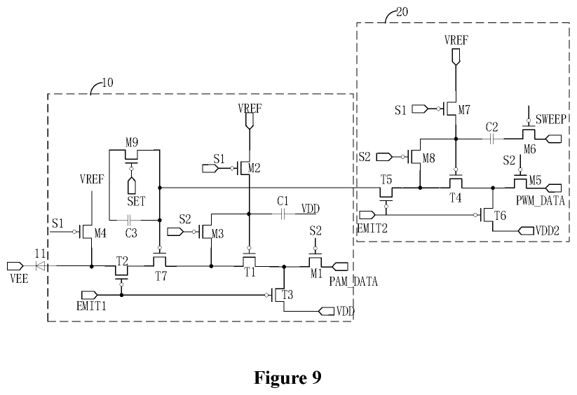

FIG. 9 is a structural diagram of a pixel driving circuit according to an embodiment of the present disclosure. As shown in FIG. 9, the amplitude modulation device further includes a third switch transistor T7 connected in series in the current driving loop including the first driving transistor T1. The pulse width modulation device 20 includes a second driving transistor T4, and the second driving transistor T4 is configured to provide, according to the potential at the control terminal of the second driving transistor T4, the turn-off voltage VDD2 to a control terminal of the third switch transistor T7.

In an embodiment of the present disclosure, the amplitude modulation device 10 further includes a third switch transistor T7, and the third switch transistor T7 is connected in series in the current driving loop including the first driving transistor T1. As exemplarily shown in FIG. 9, a first terminal of the third switch transistor T7 is electrically connected with the first driving transistor T7, a second terminal of the third switch transistor T7 is electrically connected with the light emitting element 11, and the control terminal of the third switch transistor T7 is electrically connected with the pulse width modulation device 20. The pulse width modulation device 20 includes a second driving transistor T4. The first terminal of the second driving transistor T4 receives the turn-off voltage VDD2 and the second data writing signal PWM_DATA, and the second terminal of the second driving transistor T4 is electrically connected with the control terminal of the third switch transistor T7. The second driving transistor T4 is configured to provide, according to the potential at the control terminal of the second driving transistor T4, the turn-off voltage VDD2 to the control terminal of the third switch transistor T7. The second driving transistor T4 controls a loop including the third switch transistor T7 to be on or off, to control a flow duration of the driving current in the current driving loop including the first driving transistor T1, to achieve the purpose of controlling the light emitting duration of the light emitting element 11.

In some embodiments, as shown in FIG. 9, a width-to-length ratio of a channel of the third switch transistor T7 is larger than the width-to-length ratio of the channel of the first driving transistor T1.

The flow duration of the driving current in the current driving loop including the first driving transistor T1 is controlled by controlling the third switch transistor T7 to be on or off, where the first driving transistor T1 is configured to provide a driving current for the light emitting element 11. For example, in order for the light emitting element 11 to enter a light emitting stage, the pulse width modulation device 20 controls the third switch transistor T7 to be on, and the driving current generated by the first driving transistor T1 can be transmitted to the light emitting element 11 to drive it to emit light. Therefore, a driving capability of the third switch transistor T7 should be higher than that of the first driving transistor T1, and the driving current provided by the first driving transistor T1 can completely flow to the light emitting element 11 through the first switch transistor T2, after the third switch transistor T7 is turned on. Therefore, in an embodiment of the present disclosure, the width-to-length ratio of the channel of the third switch transistor T7 is configured to be larger than the width-to-length ratio of the channel of the first driving transistor T1, and a turn-on resistance of the third switch transistor T7 is lower than that of the first driving transistor T1, to improve the driving capability of the third switch transistor T7.

In some embodiments, the width-to-length ratio of the channel of the third switch transistor T7 is larger than a width-to-length ratio of a channel of a second transistor. The second transistor is a transistor other than the first switch transistor and the second switch transistor. That is, the second transistor is a transistor other than the first switch transistor and the second switch transistor in the pixel driving circuit.

For example, as shown in FIG. 9, in an embodiment of the present disclosure, the third switch transistor T7 needs a higher driving capability, because the flow duration of the driving current in the current driving loop including the first driving transistor T1 is controlled by controlling the third switch transistor T7 to be on or off, to selectively control the light emitting element 11 to enter a light emitting stage. Therefore, the width-to-length ratio of the channel of the third switch transistor T7 is larger than the width-to-length ratio of the channel of the second transistor, to reduce the turn-on resistance of the third switch transistor T7 and the power consumption caused by turn-on resistances of the transistors in the current driving loop. Stability of the third switch transistor T7 is related to a light emitting effect of the light emitting element 11. In consideration of stability of the circuit, the driving capability of the third switch driving transistor T7 should be higher than that of the second transistor. Therefore, the turn-on resistance of the third switch transistor T7 can be reduced, to improve the driving capability and stability of the third switch transistor.

Exemplarily, continuing with FIG. 9, the above second transistor includes at least one of the first data writing transistor, the first compensation transistor, the first reset transistor or the initialization transistor, for example. The second transistor according to the embodiment of the present disclosure may be any transistor other than the first switch transistor T2 and the second switch transistor T3.

Continuing with FIG. 9, in some embodiments, the pulse width modulation device 20 includes a second driving transistor T4, and the second driving transistor T4 is configured to provide, according to the potential at the control terminal of the second driving transistor T4, the turn-off voltage VDD2 to the current driving loop including the first driving transistor T1, to control the turn-on duration of the current driving loop including the first driving transistor T1.

The width-to-length ratio of the channel of the second driving transistor T4 is larger than a width-to-length ratio of a channel of any other transistor in the pulse width modulation device 20.

Exemplarily, in the pulse width modulation device 20 according to an embodiment of the present disclosure, the first terminal of the second driving transistor T4 receives the second data writing signal PWM_DATA and the turn-on voltage VDD2, and the second terminal of the second driving transistor T4 is electrically connected with the current driving loop including the first driving transistor T1, to control the turn-on duration of the current driving loop including the first driving transistor T1. The second terminal of the second driving transistor T4 may be electrically connected with the current driving loop including the first driving transistor T1 in many ways. For example, as shown in FIG. 7, a terminal of the second driving transistor T4 is electrically connected with the control terminal of the first driving transistor T1 directly, and the second driving transistor T4, after being turned on, can transmit the turn-off voltage VDD2 to the control terminal of the first driving transistor T1. In one embodiment, as shown in FIG. 9, a terminal of the second driving transistor T4 is electrically connected with the control terminal of the third switch transistor T7. The third switch transistor T7 is in the current driving loop including the first driving transistor T1, and a current turn-on duration of the current driving loop including the first driving transistor T1 can be controlled by controlling the third switch transistor T7 to be on or off. It should be noted that a specific circuit structure of the connection between the second terminal of the second driving transistor T4 and the current driving loop including the first driving transistor T1 is not limited in the present disclosure.

A length of the channel of the second driving transistor T4 is larger than a length of a channel of any other transistor in the pulse width modulation device 20. A length of a channel of a transistor influences stability and properties of the transistor, where the larger the length of the channel is, the higher the stability and uniformity of the transistor are and the weaker the short channel effect and tunneling effect are. With higher stability, current leakage issues can be alleviated, and a driving current is more stable. The second driving transistor T4 needs a stable driving current, to provide the turn-off voltage VDD2 to the current driving loop including the first driving transistor T1 and to control the duration of the current driving loop including the first driving transistor T1. Therefore, the length of the channel of the second driving transistor T4 is increased, and the length of the channel thereof is larger than the length of the channel of any other transistor in the pulse width modulation device 20, to ensure that a source and a drain can effectively draw a current from the channel and improving the stability of the second driving transistor T4.

In some embodiments of the present disclosure, the pixel driving circuit may include other elements essential for driving the light emitting element to emit light, such as transistors and capacitors. The numbers, positions and connections of other transistors and capacitors are not limited in the embodiments of the present disclosure. Exemplary description thereof is given with reference to FIG. 9. As shown in FIG. 9, in some embodiments, the pixel driving circuit may further include a clearing transistor M9 and a third capacitor C3.

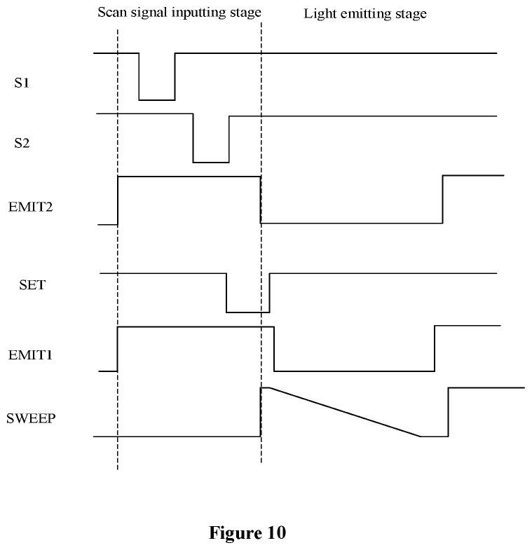

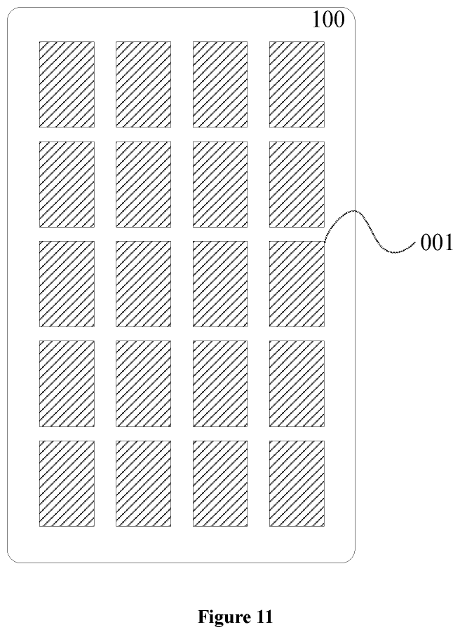

FIG. 10 is a timing sequence diagram of a pixel driving circuit according to an embodiment of the present disclosure. As shown in FIGS. 9 and 10, the amplitude modulation device 10 includes a third switch transistor T7. The control terminal of the third switch transistor T7 receives a turn-on signal SET for turning on the third switch transistor T7. The flow duration of the driving current in the current driving loop for the light emitting element 11 is controlled by controlling the third switch transistor T7 to be on or off. The amplitude modulation device 10 further includes a clearing transistor M9 and a third capacitor C3, which can turn on the third switch transistor T7 under the control of the turn-on signal SET. As shown in FIG. 9, the transistors are P-type transistors for example. Since a P-type transistor is turned on when a voltage difference between a gate and a source thereof is lower than a threshold voltage, i.e., turned on at a low level, the pulse width control signal SWEEP may be configured to fall linearly (as shown in FIG. 10).

The operation of the pixel driving circuit is elaborated hereinafter with reference to FIGS. 9 and 10. As shown in FIG. 10, one frame period consists of a scan signal inputting stage and a light emitting stage.

As the control terminal of the second driving transistor T4 is connected with the first electrode of the second capacitor C2, the voltage at the control terminal of the second driving transistor T4 will change at a slope the same as a slope of linear change of SWEEP from an initial voltage when the pulse width control signal SWEEP is inputted into the second electrode of the second capacitor C2, until it is lower than the threshold voltage of the second driving transistor. Thus, the second driving transistor T4 is turned on, and the turn-off voltage VDD2 is transmitted to the control terminal of the third switch transistor T7 through the second driving transistor T4 and turns on the third switch transistor T7. The third switch transistor T7 is in the current driving loop including the first driving transistor T1, and can control on-off of the current driving loop. The current driving loop is controlled by the turn-off voltage VDD2 to stop providing a driving current for the light emitting element 11. As can be seen from the above process, the light emitting duration of the light emitting element 11 is controlled by the first data writing signal PAM_DATA and the pulse width control signal SWEEP. The pixel driving circuit further includes a fourth switch transistor T5 and a fifth switch transistor T6. The fourth switch transistor T5 and the fifth switch transistor T6 control, under the control of the second light emitting control signal EMIT2, whether the turn-off voltage VDD2 is transmitted to the control terminal of the third switch transistor, to control whether the current driving loop including the first driving transistor T1 is turned on.

In the scan signal inputting stage, the first light emitting control signal EMIT1 is at a high level.

A low level signal is inputted as the first scan signal S1, and the first reset transistor M2 is turned on to transmit the reference voltage signal VREF to the control terminal of the first driving transistor T1. At this time, the gate voltage of the first driving transistor T1 is VREF, which resets the control terminal of the first driving transistor T1. At the same time, the first scan signal S1 also turns on the initialization transistor M4 to transmit the reference voltage signal VREF to the light emitting element 11, to reset the light emitting element 11. The first scan signal S1 is written into the second reset transistor M7, and the second reset transistor M7 is turned on, to transmit the reference voltage signal VREF to the control terminal of the second driving transistor T4. At this time, the voltage at the control terminal of the second driving transistor T4 is VREF, which resets the control terminal of the second driving transistor T4.

After enabling of the first scan signal S1 finishes, a low level signal is inputted as the second scan signal S2, to turn on the first data writing transistor M1 and transmit the first data writing signal PAM_DATA to the source of the first driving transistor T1. At this time, the first compensation transistor M3 is turned on in a synchronized manner, and the drain and the gate of the first driving transistor T1 form a loop, where the gate voltage of the first driving transistor T1 changes to PAM_DATA+Vth. The second scan signal S2 is written into the second data writing transistor M5, and at this time, the second data writing transistor M5 is turned on, to transmit the second data writing signal PWM_DATA to the source of the second driving transistor T4. At this time, the second compensation transistor M8 is turned on in a synchronized manner, and the drain and the gate of the second driving transistor T4 form a loop, to compensate for the voltage at the control terminal of the second driving transistor T4.

After enabling of the second scan signal S2 finishes, the pulse width control signal SWEEP changes linearly (for example, falls linearly), and a low level signal is inputted as the second light emitting control signal EMIT2. Whilst the second light emitting control signal EMIT2 is a low level signal, the fourth switch transistor T5 and the fifth switch transistor T6 are turned on, which enables the pulse width modulation function and transmits the turn-off voltage VDD2 to the control terminal of the third switch transistor T7. The third switch transistor T7 is turned on or off according to the potential at the control terminal thereof. The second driving transistor T4 provides, according to the potential at the control terminal of the second driving transistor T4, the turn-off voltage VDD2 to the control terminal of the third switch transistor T7. The potential at the control terminal of the second driving transistor T4 changes at the slope the same as the slope of linear change of the pulse width control signal SWEEP, until it is lower than Vth, and the second driving transistor T4 transforms from a high-impedance state to a conductive state, and the turn-off voltage VDD2 is provided to the control terminal of the third switch transistor T7. The third switch transistor T7 can control the current driving loop including the first driving transistor T to be on or off under the control of the turn-off voltage VDD2. When the current driving loop is turned off, the first driving transistor T1 cannot output a driving current to the light emitting element 11. Thus, the light emitting duration of the light emitting element 11 is controlled by the second data writing signal PWM_DATA and the pulse width control signal SWEEP combined.

At the same time, a low level signal is inputted as the first light emitting control signal EMIT1. Whilst the first light emitting control signal EMIT1 is a low level signal, the first switch transistor T2 and the second switch transistor T3 are turned on, and a driving current, generated by the first driving transistor T1 with the first power signal terminal VDD according to the first data writing signal PAM_DATA, flows through the light emitting element 11 to the second power signal terminal VEE, and the light emitting element 11 emits light. The luminance of the light emitting element 11 can be controlled by controlling the magnitude of the driving current for the light emitting element 11.

The third switch transistor T7 is turned on, and the driving current can flow through the light emitting element 11 for the light emitting element to emit light. The clearing transistor M9 may be controlled by a turn-on signal, and the third switch transistor T7 can be controlled to turn on at a start point of each light emitting stage. The circuit may further include a third capacitor C3 to stabilize the circuit.

It should be noted that the transistors in the embodiments of the present disclosure may be configured as N-type transistors alternatively. In a case that the transistors are N-type transistors, the pulse width control signal SWEEP may be configured to rise linearly, as an N-type transistor is turned on when a voltage difference between a gate and a source thereof is higher than a threshold voltage, i.e., turned on at a high level. The operation principle thereof is similar as in the above embodiment, which is not described redundantly herein.

A display panel is further provided according to the present disclosure. FIG. 11 is a structural diagram of a display panel according to an embodiment of the present disclosure. As shown in FIG. 11, the display panel 100 includes the pixel driving circuit according to the above embodiments. Multiple pixel driving circuits 100 may be arranged in an array along a row-wise direction and a column-wise direction.

A display device is further provided according to the present disclosure, which includes the display panel according to any of the above embodiments. Therefore, the display device includes the features of the display panel according to the embodiments of the present disclosure, and can achieve the beneficial effects achieved by the display panel according to the embodiments of the present disclosure. Reference may be made to the above description of the display panel according to the embodiments of the present disclosure for same parts, which is not redundantly described herein.

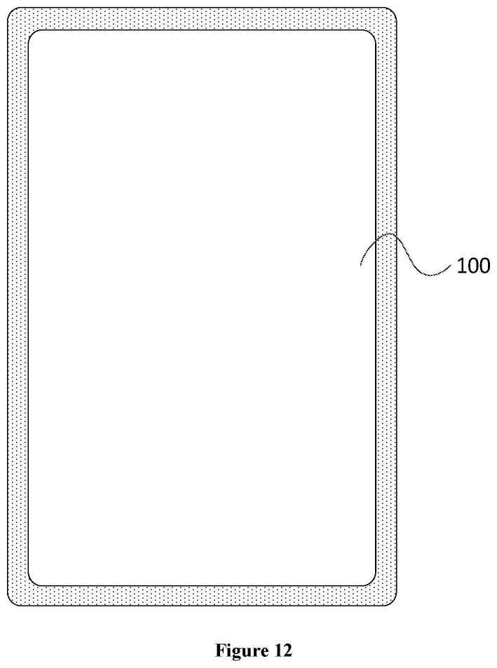

Exemplarily, FIG. 12 is a structural diagram of a display device according to an embodiment of the present disclosure. As shown in FIG. 12, the display device according to the embodiment of the present disclosure includes the display panel 100 according to any of the above embodiments of the present disclosure. In FIG. 12, the display device is described taking a cellphone for example. It is understandable that the display device according to the embodiments of the present disclosure may be any electronic product with a display function, which includes, but is not limited to, a cellphone, a television, a laptop computer, a desktop computer, a tablet computer, a digital camera, a smart bracelet, a smart glasses, an on-board display, medical equipment, industrial control equipment or a touch interaction terminal, which is not limited in the embodiments of the present disclosure.

The display device according to the embodiments of the present disclosure includes the above-describe display panel, and therefore can solve the same problem with the display panel according to the above embodiments, and achieve the same effects, which are not redundantly described herein.

It should be noted that in the specification, terms such as “first” and “second” are intended to distinguish one entity or operation with one another, but do not necessarily indicate a specific order or sequence between these entities or operations. In addition, the terms “include”, “contain” and any other variants mean to cover the non-exclusive inclusion, and a process, method, item, or device that includes a series of elements is not necessarily limited to those elements, but may include other elements not expressly listed or inherent to such a process, method, item, or device. Without further limitations, an element preceded by the statement “including a” does not exclude the existence of other same elements in the process, method, item, or device including the element.

What is claimed is:

1. A pixel driving circuit, comprising a light emitting element and an amplitude modulation device,
wherein the amplitude modulation device comprises a first driving transistor, a first switch transistor and a second switch transistor,
the first driving transistor is configured to provide a driving current for the light emitting element,
the first switch transistor and the second switch transistor are configured to selectively control the light emitting element to enter a light emitting stage, and
a width-to-length ratio of a channel of the first switch transistor is different from a width-to-length ratio of a channel of the second switch transistor.

2. The pixel driving circuit according to claim 1, further comprising a pulse width modulation device,
wherein the pulse width modulation device is configured to control a light emitting duration of the light emitting element.

3. The pixel driving circuit according to claim 1, wherein the first switch transistor and the second switch transistor are P-type transistors,
the first switch transistor is connected in series between the first driving transistor and the light emitting element,
the second switch transistor is connected in series between the first driving transistor and a first power signal terminal,
a cathode of the light emitting element is connected with a second power signal terminal, and
the width-to-length ratio of the channel of the first switch transistor is larger than the width-to-length ratio of the channel of the second switch transistor.

4. The pixel driving circuit according to claim 1, wherein the first switch transistor and the second switch transistor are N-type transistors,
the first switch transistor is connected in series between the first driving transistor and the light emitting element,
the second switch transistor is connected in series between the first driving transistor and a first power signal terminal,
a cathode of the light emitting element is connected with a second power signal terminal, and
the width-to-length ratio of the channel of the second switch transistor is larger than the width-to-length ratio of the channel of the first switch transistor.

5. The pixel driving circuit according to claim 1, wherein the first switch transistor is an N-type transistor, the second switch transistor is a P-type transistor,
the first switch transistor is connected in series between the first driving transistor and the light emitting element,
the second switch transistor is connected in series between the first driving transistor and a first power signal terminal,
a cathode of the light emitting element is connected with a second power signal terminal, and
the width-to-length ratio of the channel of the second switch transistor is larger than the width-to-length ratio of the channel of the first switch transistor.

6. The pixel driving circuit according to claim 1, wherein a width-to-length ratio of a channel of at least one of the first switch transistor, the second switch transistor and the first driving transistor is larger than a width-to-length ratio of a channel of a first transistor,
wherein the first transistor is a transistor other than the first switch transistor, the second switch transistor and the first driving transistor.

7. The pixel driving circuit according to claim 6, wherein width-to-length ratios of channels of the first switch transistor, the second switch transistor and the first driving transistor are all larger than the width-to-length ratio of the channel of the first transistor.

8. The pixel driving circuit according to claim 1, wherein the width-to-length ratio of the channel of the first switch transistor is larger than a width-to-length ratio of a channel of the first driving transistor, and/or
the width-to-length ratio of the channel of the second switch transistor is larger than the width-to-length ratio of the channel of the first driving transistor.

9. The pixel driving circuit according to claim 1, wherein a length of a channel of the first driving transistor is larger than a length of a channel of any other transistor in the amplitude modulation device.

10. The pixel driving circuit according to claim 2, wherein the pulse width modulation device comprises a second driving transistor,
the second driving transistor is configured to provide, according to a potential at a control terminal of the second driving transistor, a turn-off voltage to a current driving loop comprising the first driving transistor, to control a turn-on duration of the current driving loop comprising the first driving transistor, and
a width-to-length ratio of a channel of the first driving transistor is larger than a width-to-length ratio of a channel of the second driving transistor.

11. The pixel driving circuit according to claim 10, wherein the amplitude modulation device comprises a first capacitor, the pulse width modulation device comprises a second capacitor,
the first capacitor is electrically connected with a control terminal of the first driving transistor, the second capacitor is electrically connected with the control terminal of the second driving transistor, and
a capacitance of the second capacitor is smaller than a capacitance of the first capacitor.

12. The pixel driving circuit according to claim 2, wherein the pulse width modulation device comprises a second driving transistor, and
the second driving transistor is configured to provide, according to a potential at a control terminal of the second driving transistor, a turn-off voltage to a control terminal of the first driving transistor.

13. The pixel driving circuit according to claim 12, wherein the amplitude modulation device comprises a first data writing transistor,
the first data writing transistor selectively provides a first data writing signal for the control terminal of the first driving transistor,
the pulse width modulation device further comprises a second data writing transistor,
the second data writing transistor selectively provides a second data writing signal for the control terminal of the second driving transistor, and
a width-to-length ratio of a channel of the first data writing transistor is smaller than or equal to a width-to-length ratio of a channel of the second data writing transistor.

14. The pixel driving circuit according to claim 12, wherein the pulse width modulation device further comprises a second data writing transistor,
the second data writing transistor is configured to selectively provide a second data writing signal for the control terminal of the second driving transistor, and
a width-to-length ratio of a channel of the second data writing transistor is smaller than or equal to a width-to-length ratio of a channel of the second driving transistor.

15. The pixel driving circuit according to claim 12, wherein the pulse width modulation device further comprises a sweeping transistor,
the sweeping transistor is configured to transmit a pulse width control signal to the control terminal of the second driving transistor, and
a width-to-length ratio of a channel of the sweeping transistor is smaller than or equal to a width-to-length ratio of a channel of the second driving transistor.

16. The pixel driving circuit according to claim 2, wherein the amplitude modulation device further comprises a third switch transistor connected in series in a current driving loop comprising the first driving transistor,
the pulse width modulation device comprises a second driving transistor, and
the second driving transistor is configured to provide, according to a potential at a control terminal of the second driving transistor, a turn-off voltage to a control terminal of the third switch transistor.

17. The pixel driving circuit according to claim 16, wherein a width-to-length ratio of a channel of the third switch transistor is larger than a width-to-length ratio of a channel of the first driving transistor; or,
a width-to-length ratio of a channel of the third switch transistor is larger than a width-to-length ratio of a channel of a second transistor,
wherein the second transistor is a transistor other than the first switch transistor and the second switch transistor.

18. The pixel driving circuit according to claim 2, wherein the pulse width modulation device comprises a second driving transistor,
the second driving transistor is configured to provide, according to a potential at a control terminal of the second driving transistor, a turn-off voltage to a current driving loop comprising the first driving transistor, to control a turn-on duration of the current driving loop comprising the first driving transistor, and
a width-to-length ratio of a channel of the second driving transistor is larger than a width-to-length ratio of a channel of any other transistor in the pulse width modulation device.

19. A display panel comprising a pixel driving circuit,
wherein the pixel driving circuit comprises a light emitting element and an amplitude modulation device,
wherein the amplitude modulation device comprises a first driving transistor, a first switch transistor and a second switch transistor,
the first driving transistor is configured to provide a driving current for the light emitting element,
the first switch transistor and the second switch transistor are configured to selectively control the light emitting element to enter a light emitting stage, and
a width-to-length ratio of a channel of the first switch transistor is different from a width-to-length ratio of a channel of the second switch transistor.

20. A display device comprising a display panel,
wherein the display panel comprises a pixel driving circuit,
wherein the pixel driving circuit comprises a light emitting element and an amplitude modulation device,
wherein the amplitude modulation device comprises a first driving transistor, a first switch transistor and a second switch transistor,
the first driving transistor is configured to provide a driving current for the light emitting element,
the first switch transistor and the second switch transistor are configured to selectively control the light emitting element to enter a light emitting stage, and
a width-to-length ratio of a channel of the first switch transistor is different from a width-to-length ratio of a channel of the second switch transistor.
